(19) United States
(12) Patent Application Publication
(10) Pub. No.: US 2005/0156916 A1
(43) Pub. Date: Jul. 21, 2005

(54) Differentially sectioned sensing rotary disc

(75) Inventor: Nien-Tsu Chen, Taipei (TW)

Correspondence Address: Mr. Peter F. Corless;EDWARDS & ANGELL, LLP, 101 Federal Street, Boston, MA, 02110, US

(73) Assignee: INVENTEC MULTIMEDIA & TELECOM CORPORATION

(21) Appl. No.: 10/750,465

(22) Filed: Dec. 30, 2003

(51) Int. Cl. G09G 5/00

(52) U.S. Cl. 345/184

(57) ABSTRACT

A differentially sectioned sensing rotary disc includes a ring body having a plurality of positioning grooves on its outer circumference and a knob having at least one protrusion on its inner circumference, wherein a sensing switch is provided between every two adjacent positioning grooves. The knob is ring-shaped and coaxially surrounds the ring body. The protrusion on the knob corresponds in position to one of the positioning grooves on the ring body. When the knob is turned, the protrusion on the knob turns is moved from the corresponding positioning groove to another adjacent positioning groove and actuates the sensing switch between the two adjacent positioning grooves so as to achieve differentially sectioned actuation.

### FIELD OF THE INVENTION

The present invention relates to differentially sectioned sensing rotary discs, and more particularly, to a rotary disc consisting of a ring body and a knob, on the outer circumference of the ring body there are formed a plurality of positioning grooves and a sensing switch between every two adjacent positioning grooves, wherein the knob is turned to allow a protrusion on its inner circumference to actuate a sensing switch between two adjacent positioning grooves on the ring body such that differentially sectioned actuation of the sensing switches is achieved.

### BACKGROUND OF THE INVENTION

For a conventional VHS (video home system) or β video recorder, to fast-forward or rewind a playing video, a FWD button a2 or a REV button a1 on a face panel of the video recorder a is pressed as shown in FIG. 8, or a FwD button b2 or a REV button on a remote control b can be operated as shown in FIG. 9. However, the use of such REV buttons a1, b1 and FWD buttons a2, b2 is not very convenient. Usually after the video is fast-forwarded or rewound to a desired scene, a STOP button a3 or b3 on the video recorder a or remote control b should be pressed to stop the video playing, and then a PLAY button a4 or b4 is pressed to resume the playing. Alternatively, after fast-forwarding or rewinding to the desired scene, a PAUSE button a6 or b6 is pressed to pause the video playing, and then the PLAY button a4 or b4 is pressed to restart the playing. However both the above operations interrupt the playback longer than necessary in order to locate the desired scene and diminish the audience experience.

To reduce scene interruption during fast-forwarding or rewinding, a rotary disc a5, b5 is provided on the video recorder a or the remote control b, as shown in FIGS. 8 and 9. The rotary disc a5, b5 comprises a stop button a51, b51 and a play button a52, b52. During the video playing, the rotary disc a5, b5 can be operated or turned to fast-forward or rewind the video at different speeds. For example, slight turning of the rotary disc a5, b5 activates a slower speed of fast-forwarding or rewinding, and great turning of the rotary disc a5, b5 gives a higher speed of fast-forwarding or rewinding. However, since there is no fine-positioning mechanism for the rotary disc a5, b5, users turn the rotary disc a5, b5 to a random extent, making fast-forwarding or rewinding operate at a variable or unstable speed. Under this condition, a motor used in a conventional VHS video recorder for fast-forwarding or rewinding the videotape would easily fail mechanically, or the tape may be damaged or broken. Hence, the conventional rotary disc a5, b5 has some disadvantages that need to be improved.

Further, along with electronic technology progression, conventional analog storage has given way to digital storage that provides larger capacity for data storage and easy access to the stored data. For example, a VCD (video compact disc) or DVD (digital videodisc) player or recorder, digital video recorder (DVR) or personal video recorder (PVR) etc employs the advanced digital storage technology. However, these electronic devices still require fast-forwarding or rewinding of the video tape to be operated through the REV button a1, b1 or FWD button a2, b2 but not having a rotary disc a5, b5.

In case of the conventional rotary disc a5, b5 provided to the electronic devices such as VCD, DVD, DVR or PVR, since the buffer size and access speed are limited for digital access to data, if the data to be accessed exceeds the buffer size or the access speed is too fast, playback anomalies occur, and it is not reliable to access scenes using the conventional rotary disc a5, b5. Thus, such a problem remains to be solved.

### SUMMARY OF THE INVENTION

A primary objective of the present invention is to provide a differentially sectioned sensing rotary disc having a ring body and a knob, on the outer circumference of the ring body there are formed a plurality of positioning grooves and a sensing switch between every two adjacent positioning grooves, wherein the knob is turned to allow a protrusion on its inner circumference to actuate a sensing switch between two adjacent positioning grooves on the ring body such that differentially sectioned actuation of the sensing switches is achieved.

Another objective of the present invention is to provide a differentially sectioned sensing rotary disc having a ring body and a knob, with an operating panel mounted to the ring body and comprising a plurality of contact switches including a confirmation button in the center and four direction buttons around the confirmation button for inputting directional signals.

A further objective of the present invention is to provide a differentially sectioned sensing rotary disc having a ring body and a knob, with a joystick mechanism mounted at the center of the ring body for inputting directional signals.

A further objective of the present invention is to provide a differentially sectioned sensing rotary disc having a ring body and a knob, wherein sensing switches on the ring body are connected to a display unit that displays an actuation status.

To achieve the above and other objectives, the present invention provides a differentially sectioned sensing rotary disc, comprising a ring body having a plurality of positioning grooves and a plurality of sensing switches on its outer circumference, wherein each of the sensing switches is provided between every two adjacent positioning grooves; and a ring-shaped knob coaxially surrounding the ring body and formed with at least one protrusion on its inner circumference, the protrusion corresponding in position to one of the positioning grooves on the ring body such that when the knob is turned, the protrusion on the knob is moved from the corresponding positioning groove to an adjacent one of the positioning grooves and actuates the sensing switch between the two adjacent positioning grooves so as to achieve differentially sectioned actuation of the sensing switches.

An operating panel may be formed at the center of the ring body and comprises a plurality of contact switches. The contact switches include a confirmation button in the center and four direction buttons around the confirmation button for inputting directional signals. Alternatively, a joystick mechanism may be mounted at the center of the ring body, having a plurality of contact switches also for inputting directional signals.

In addition, a display unit is connected to the sensing switches on the ring body and displays an actuation status of the sensing switches to notify a user of the status when turning the knob.

### BRIEF DESCRIPTION OF THE DRAWINGS

The present invention can be more fully understood by reading the following detailed description of the preferred embodiments, with reference made to the accompanying drawings, wherein:

FIG. 1 is a cross-sectional view of a differentially sectioned sensing rotary disc according to the present invention;

FIG. 2 is a front view of the differentially sectioned sensing rotary disc with an operating panel according to the present invention;

FIG. 3 is a cross-sectional view of the differentially sectioned sensing rotary disc with the operating panel according to the present invention;

FIG. 4 is a perspective view of the differentially sectioned sensing rotary disc with a joystick mechanism according to the present invention;

FIG. 5 is a cross-sectional view of the differentially sectioned sensing rotary disc with the joystick mechanism according to the present invention;

FIG. 6 is a front view of the differentially sectioned sensing rotary disc according to the present invention with light-emitting diodes as a display unit;

FIG. 7 is a front view of the differentially sectioned sensing rotary disc according to the present invention with a liquid crystal display as the display unit;

FIG. 8 (PRIOR ART) is a front view of a face panel for a conventional video recorder/player, VCD, DVD, DVR or PVR device; and

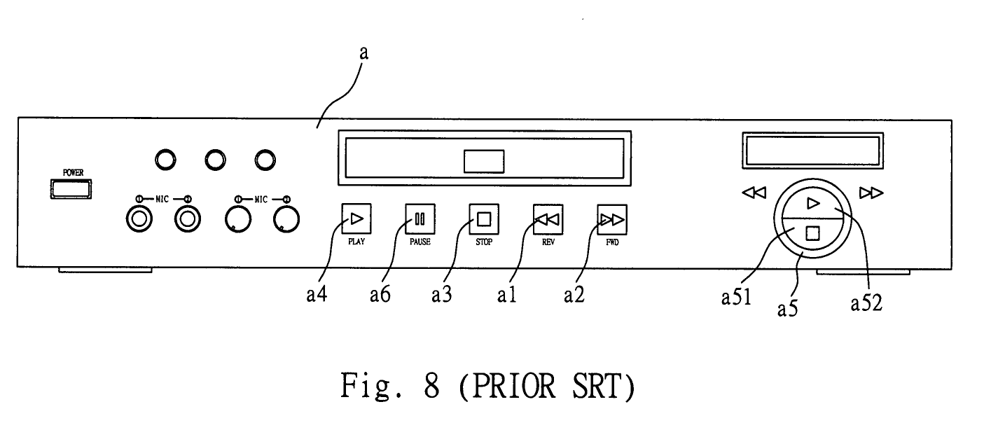

FIG. 9 (PRIOR ART) is a perspective view of a conventional remote control.

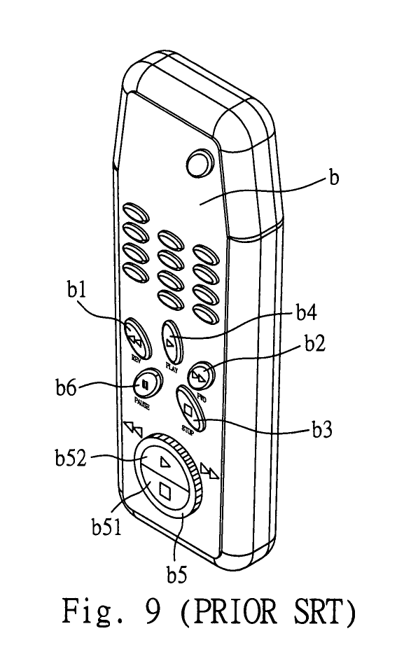

### DETAILED DESCRIPTION OF THE PREFFERED EMBODIMENT

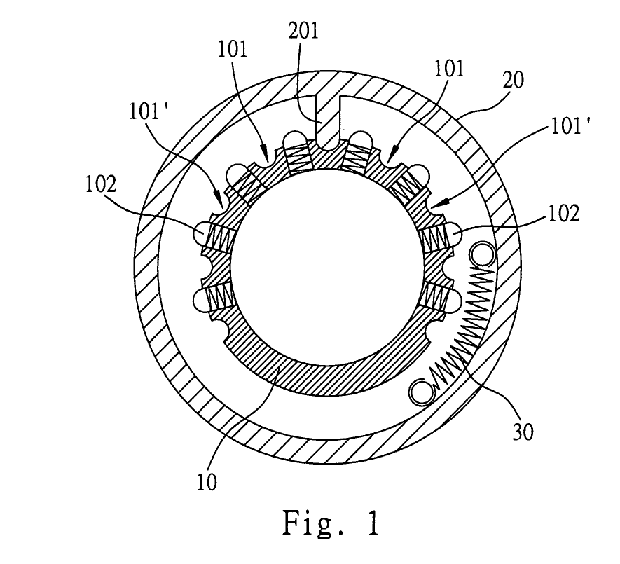

Referring to FIG. 1, a differentially sectioned sensing rotary disc proposed by the present invention includes a ring body 10 and a knob 20.

The ring body 10 is a ring-shaped casing formed with a plurality of positioning grooves 101 and a plurality of sensing switches 102 on its outer circumference. Each sensing switch 102 is located between every two adjacent positioning grooves 101. The sensing switch 102 can be a spring-actuated switch.

The knob 20 is ring-shaped and coaxially surrounds the ring body 10. At least one protrusion 201 is provided on the inner circumference of the knob 20. The protrusion 201 corresponds in position to and extends into one corresponding positioning groove 101 on the outer circumference of the ring body 10.

When the knob 20 is turned, the protrusion 201 on the knob 20 is moved from the corresponding positioning groove 101 to an adjacent positioning groove 101′ and touches and actuates the sensing switch 102 between the two adjacent positioning grooves 101 and 101′, causing the sensing switch 102 to output a signal. In this manner, during turning of the knob 20 to actuate the sensing switch 102, coupling between the protrusion 201 and the positioning groove 101 or 101′ determines a position to which the knob 20 being turned, and actuation of the sensing switches 102 can be differentially sectioned, such that the prior-art problem of unstable signal outputs due to uncertain turning extents or positions for the conventional rotary disc can be avoided.

The differentially sectioned sensing rotary disc according to the present invention is suitably used in an electronic device such as VHS recorder, VCD, DVD, DVR or PVR. Since the turning position of the knob 20 can be determined by the coupling between the protrusion 201 and one corresponding positioning groove 101 of the ring body 10, signals can be stably output from the sensing switches 102 without causing damage to the above electronic device by too frequent unstable mechanical motions of the electronic device. Therefore, the use of the differentially sectioned sensing rotary disc according to the present invention facilitates the operation and prolongs the lifetime of the electronic device.

Moreover, the knob 20 can return to its starting position via an elastic member such as a spring 30. After the knob 20 is turned clockwise or counterclockwise by a user, it returns to the starting position by means of the elastic force from the spring 30 when the user releases the knob 20.

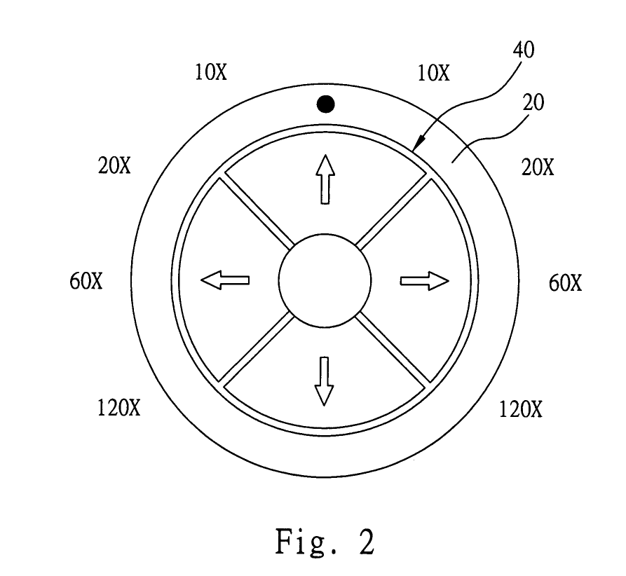

As shown in FIGS. 1 and 2, the plurality of sensing switches 102 on the outer circumference of the ring body 10 can be divided into two sets, i.e. left and right sets with reference to the black dot in FIG. 2. When the knob 20 is turned clockwise or counterclockwise, the protrusion 201 thereon can correspondingly reach the right or left set of sensing switches 102. For example, the sensing switches 102 in the left or right set correspond to various playback speeds such as 10 times (10×), 20 times (20×), 60 times (60×) and 120 times (120×), such that they function to select one of the playback speeds in either the clockwise (e.g. fast-forward) or counterclockwise (e.g. rewind) turning direction of the knob 20.

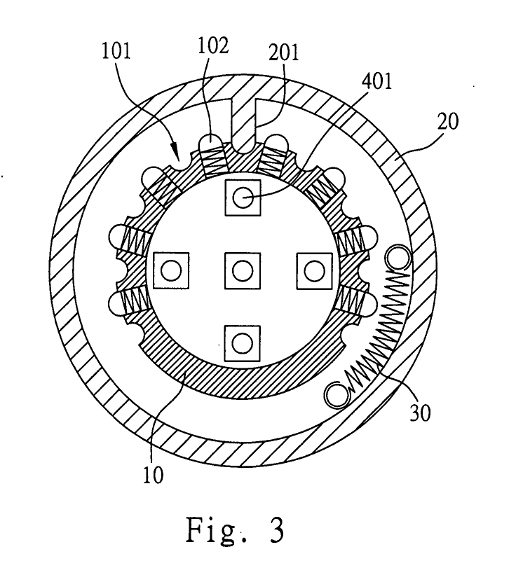

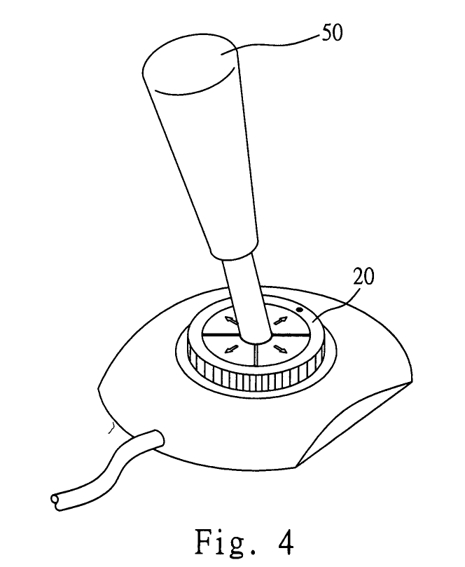

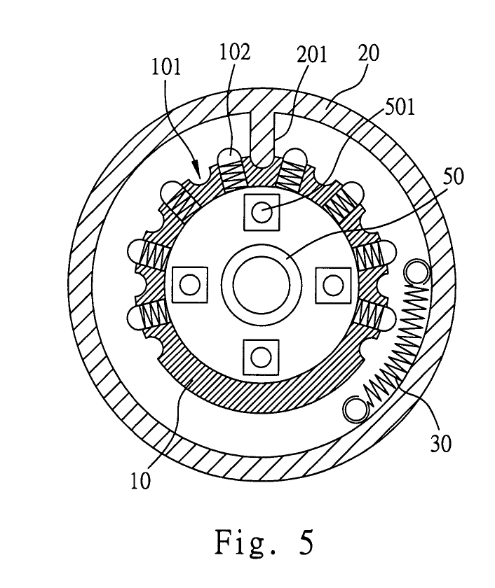

Referring to FIGS. 2 and 3, an operating panel 40 can be provided at the center of the ring body 10 and comprises a plurality of contact switches 401. The contact switches 401 include a confirmation button in the center and four direction buttons around the confirmation button for inputting directional signals. Alternatively, referring to FIGS. 4 and 5, a joystick mechanism 50 may be provided at the center of the ring body 10. A plurality of contact switches 501 are located underneath the joystick mechanism 50 and can be actuated by the joystick mechanism 50. The contact switches 501 can also be used to input directional signals, making the joystick mechanism 50 suitable for a gaming machine for example.

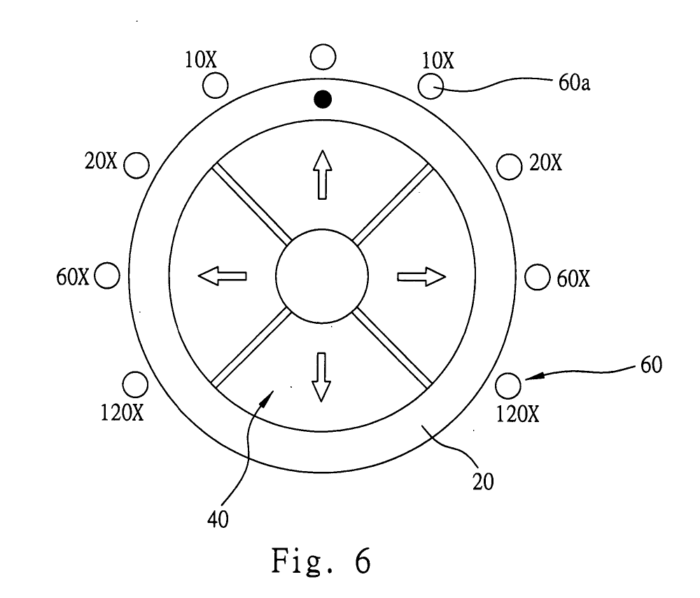

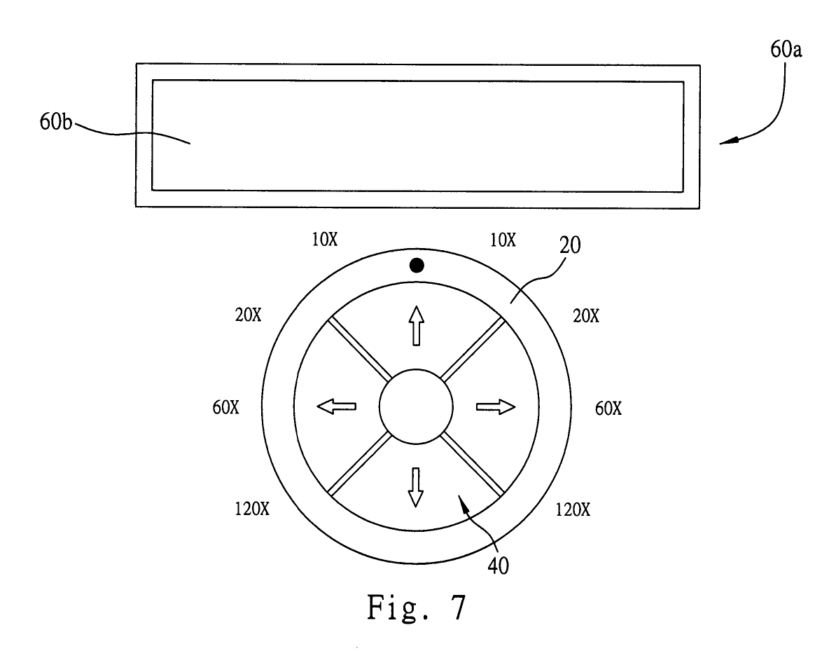

Referring to FIGS. 6 and 7, the sensing switches 102 are connected to a display unit 60 that displays an actuation statues of the sensing switches 102 to notify the user whether the knob 20 being turned has actuated the sensing switches 102.

As shown in FIG. 6, the display unit 60 comprises a plurality of light-emitting diode (LEDs) 60a, wherein these LEDs 60a are located adjacent to the sensing switches 102 set with variable playback speeds of 10×, 20×, 60× and 120× and around the outer circumference of the knob 20, such that a luminescing LED 60a indicates which the playback speed such as 10×, 20×, 60× or 120× being actuated.

As shown in FIG. 7, the display unit 60 comprises a liquid crystal display (LCD) 60b. The LCD 60b may display which playback speed such as 10×, 20×, 60× or 120× being actuated and also a symbol for fast-forwarding or rewinding.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A differentially sectioned sensing rotary disc, comprising:
a ring body having a plurality of positioning grooves and a plurality of sensing switches on its outer circumference, wherein each of the sensing switches is provided between every two adjacent positioning grooves; and
a ring-shaped knob coaxially surrounding the ring body and formed with at least one protrusion on its inner circumference, the protrusion corresponding in position to one of the positioning grooves on the ring body such that when the knob is turned, the protrusion on the knob is moved from the corresponding positioning groove to an adjacent one of the positioning grooves and actuates the sensing switch between the two adjacent positioning grooves so as to achieve differentially sectioned actuation of the sensing switches.

2. The differentially sectioned sensing rotary disc of claim 1, wherein the knob is capable of returning to its starting position via an elastic member.

3. The differentially sectioned sensing rotary disc of claim 2, wherein the elastic member is a spring.

4. The differentially sectioned sensing rotary disc of claim 1, wherein the sensing switch is a spring-actuated switch.

5. The differentially sectioned sensing rotary disc of claim 1, wherein the knob is capable of being turned clockwise or counterclockwise to actuate the sensing switches.

6. The differentially sectioned sensing rotary disc of claim 1, wherein an operating panel is provided at the center of the ring body.

7. The differentially sectioned sensing rotary disc of claim 6, wherein the operating panel comprises a plurality of contact switches.

8. The differentially sectioned sensing rotary disc of claim 7, wherein the plurality of contact switches comprise a confirmation button at the center and four direction buttons around the confirmation button.

9. The differentially sectioned sensing rotary disc of claim 1, wherein a joystick mechanism is provided at the center of the ring body, with a plurality of contact switches formed underneath the joystick mechanism and capable of being actuated by the joystick mechanism.

10. The differentially sectioned sensing rotary disc of claim 1, wherein the sensing switches are connected to a display unit that displays an actuation status of the sensing switches.

11. The differentially sectioned sensing rotary disc of claim 10, wherein the display unit comprises a plurality of light-emitting diodes (LEDs).

12. The differentially sectioned sensing rotary disc of claim 10, wherein the display unit is a liquid crystal display (LCD).
